(19) United States
(12) Patent Application Publication
(10) Pub. No.: US 2023/0373327 A1
(43) Pub. Date: Nov. 23, 2023

(54) CHARGING STATION

(71) Applicant: AUDI AG, Ingolstadt (DE)

(72) Inventor: Sebastian VAHLE, Landshut (DE)

(21) Appl. No.: 18/317,778

(22) Filed: May 15, 2023

(30) Foreign Application Priority Data
May 17, 2022 (DE) 10 2022 112 278.6

(51) Int. Cl. B60L 53/30; B60L 53/18; B60L 53/16

(52) U.S. Cl. CPC B60L 53/30; B60L 53/18; B60L 53/16

(57) ABSTRACT

A system for a charging station having an integrated swiveling charging cable conduit and a method for its operation.

### BACKGROUND

### Technical Field

Embodiments of the present disclosure relate to a charging station having an integrated swiveling charging cable conduit and a method for its operation.

### Description of the Related Art

Charging stations are known, serving for the charging of plug-in hybrid electric vehicles (PHEV) and battery electric vehicles (BEV). The charging cable is either a component of the charging station or the charging station has only one charging receptacle and the vehicle's own charging cable is used as the charging cable. In the case of charging stations with integrated charging cable, the charging cable is generally situated at the height of the user and is freely accessible. When the charging cable is attached to the vehicle (either a charging cable permanently installed at the charging station or the vehicle's own charging cable), the charging cable lies loose on the ground or hangs down at the bridging height between the charging station and the car. There is a danger of passers by getting caught on the cable or tripping over the cable, especially since the charging process for electric vehicles takes a long time and the owner of the vehicle is not present at the vehicle and watching the charging process, so they cannot warn passersby. Furthermore, there is the danger of a damaging of the charging cable and a fouling of the charging cable due to dirt and grime.

From the document WO 2020/157 442 A1 there is known a charging system in which a charging cable is formed from rigid guides which can be folded along their length in order to stow the charging cable in the vehicle, or in which the charging cable consists of a telescopic sheath surrounding the conductor wires, or the conductor wires are wound up in a sliding device, consisting of a stationary part and a movable part sliding along a rail.

The document DE 10 2016 112 613 B4 relates to a charging connection for a charging station for electric vehicles, comprising a subfloor housing which can be closed with a cover and at least one electrical connector arranged at least in the resting state inside the subfloor housing, which is connected to a charging cable or provided for temporary connection of a charging cable, the cover being closed during the charging process with the charging cable led out from the subfloor housing.

The document EP 2 323 237 A2 discloses a charging station for electric vehicles, which is provided with electricity by a lamp post and secured either directly on the lamp post or indirectly across a power supply cable to an inspection cover or integrated in the pavement or mounted on the street curb.

### BRIEF SUMMARY

Some embodiments provide a device and a method which reduce the danger of tripping over charging cables lying around and protect the charging cable against damage and fouling with dirt and grime.

Some embodiments include a charging station for an electric vehicle, having a horizontal boom with a charging cable conduit situated at its front side at the base of the charging station. The boom is connected by a swivel mechanism to the charging station and can swivel by the swivel mechanism horizontally to either side and be locked in a desired position.

The horizontal boom is arranged at the base of the charging station on its front side, and extends in the direction of an electric vehicle being charged at the charging station. At least in the locked state, the boom lies on the ground. In one embodiment, the boom has a trapezoidal cross section.

The boom comprises a charging cable conduit, which is adapted to receive a segment of a charging cable and secure it. The charging cable conduit is open at the top. In one embodiment, the charging cable conduit runs along the longitudinal axis of the boom. In another embodiment, the charging cable conduit runs in the middle of the boom along the center axis of the boom.

In one embodiment, the boom has a movable cover, which is adapted to opening or closing the charging cable conduit. The charging cable conduit is provided with an additional cover, which additionally secures the charging cable in the charging cable conduit, for example, a flap which can be folded up or down, or slid open or closed. In another embodiment, the movable cover has a flap which can turn about a hinge running parallel to the charging cable conduit. In an alternative embodiment, the movable cover has a slider which is received in a slot running in a side wall of the charging cable conduit.

In one embodiment, the boom is provided with a warning marking, such as a warning paint coat (black/yellow or red/white).

The boom of the charging station is connected by a swivel mechanism to the charging station. Using the swivel mechanism, the boom can swivel horizontally to either side and be locked in a desired position. In one embodiment, the swivel mechanism is locked and unlocked by a foot switch. In another embodiment, the swivel mechanism is adapted to lift the boom up from the ground when the swivel mechanism is unlocked, and to lower the boom to the ground when the swivel mechanism is locked. In this embodiment, the swivel mechanism may also comprise a lifting and lowering mechanism.

In one embodiment, the charging station has at least one charging receptacle on its front side. A charging plug of a charging cable can be inserted into the at least one charging receptacle.

Some embodiments provide a method for operating a charging station. In the method, the boom is swiveled in the horizontal direction until it points in the direction of a charging socket of an electric vehicle being charged, and it is then locked in this position. A segment of a charging cable connecting the charging station and the electric vehicle is introduced into the charging cable conduit of the boom and secured there. In one embodiment of the method, the charging cable is secured by closing a cover of the charging cable conduit.

A user of the charging station connects his charging cable to the charging station and his vehicle and lays the charging cable in the region between charging station and vehicle in the charging cable conduit. In this way, the charging cable is led in the charging cable conduit and the danger of tripping is reduced. In order to place the end of the charging cable conduit which is further away from the charging station as close as possible to the charging receptacle of the vehicle, which may be situated in various positions on the vehicle, the boom with the charging cable conduit can swivel horizontally (about a vertical axis) after being unlocked.

In one embodiment of the method, the charging cable is a separate charging cable, having a charging plug at both ends. One charging plug is inserted into a charging socket of the charging station and the charging plug at the other end is inserted into a charging socket of the electric vehicle.

In another embodiment of the method, one end of the charging cable is firmly attached to the charging station and comprises a charging plug at its other end, which is inserted into a charging socket of the electric vehicle.

In yet another embodiment of the method, one end of the charging cable is firmly attached to the charging station and comprises a charging plug at its other end, which is inserted into a charging socket of the charging station.

In one embodiment of the method, after the charging process is completed the cover of the charging cable conduit is opened once again and the segment of the charging cable secured in the charging cable conduit of the boom is removed.

Thanks to the charging station with swiveling boom described herein, the danger of tripping due to charging cables lying around is reduced. Furthermore, the charging cable does not become so dirty in use, since it does not lie on the ground, and it is protected against damage. By swiveling the boom, it can be oriented to the position of the charging socket of an electric vehicle being charged, so that the open lying portion of a charging cable connecting the charging station and the electric vehicle is minimized. Embodiments of the present disclosure can be implemented both in charging stations with no fixed charging cable and in charging stations with a fixed charging cable. Further benefits and embodiments of the disclosure will emerge from the specification and the drawings.

Of course, the previously mentioned features can be used not only in the particular indicated combination, but also in other combinations or standing alone, without leaving the scope of the present disclosure.

### BRIEF DESCRIPTION OF THE SEVERAL VIEWS OF THE DRAWINGS

The disclosure is presented schematically with the aid of embodiments in the drawings and shall be further described with reference to the drawings.

FIG. 1 shows a schematic representation of one embodiment of the charging station.

FIG. 2 shows a cross section of one embodiment of the boom of a charging station.

FIG. 3 shows a cross section of an alternative embodiment of the boom of the charging station.

### DETAILED DESCRIPTION

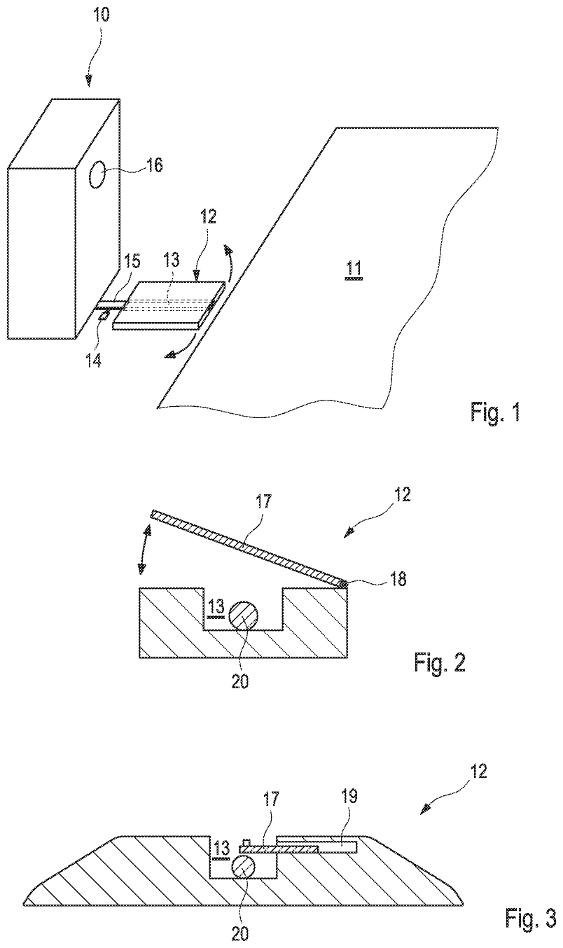

FIG. 1 shows schematically one embodiment of the charging station 10 situated next to a parking place 11 for an electric vehicle being charged. At the front side of the charging station 10 there is a charging receptacle 16, in which a charging plug of a charging cable 20 can be inserted. At the base of the charging station 10, on its front side, there is situated a horizontal boom 12, extending from the charging station 10 in the direction of the parking place 11. The boom 12 is connected by a swivel mechanism 15 to the charging station 10 and can swivel to either side by the swivel mechanism 15, as indicated by arrows in the drawing.

The swivel mechanism 15 is locked and unlocked by a foot switch 14. The boom 12 lies on the ground when the swivel mechanism 15 is locked. In one embodiment, the swivel mechanism 15 also comprises a lifting and lowering function. When the foot switch 14 is activated and the swivel mechanism 14 is unlocked, the boom 12 is lifted slightly off the ground and is then easier to swivel in the horizontal direction. When the swivel mechanism 15 is locked, the boom 12 is again lowered to the ground. The boom 12 comprises a cable conduit 13, running in the longitudinal direction of the boom 12 and adapted to receive and secure a charging cable 20. By swiveling the boom 12 in the horizontal, i.e., about a vertical axis, near the front side of the charging station 10, the end of the cable conduit 13 is positioned as close as possible to the charging receptacle of the vehicle, which may be located in various positions on the vehicle.

FIG. 2 shows a cross section of one embodiment of the boom 12 of the charging station 10. The boom 12 has a flap 17 which can swivel about a hinge 18 in order to cover the cable conduit 13. The drawing shows the flap 17 in the opened state. After placing a charging cable 20 in the cable conduit 13, the flap 17 is closed and covers the cable conduit 13, so that the charging cable 20 is secured and protected against damage and dirt. The flap 17 is opened once more in order to remove the charging cable 20 after the completion of the charging process.

FIG. 3 shows a cross section of an alternative embodiment of the boom 12 of the charging station 10. The boom 12 has a trapezoidal cross section, which further lessens the danger of tripping. In the drawing, a charging cable 20 is located in the cable conduit 13 of the boom 12. The cable conduit 13 is located in the middle of the boom 12 and runs in the longitudinal direction of the boom 12. The cable conduit 13 can be opened and closed by a movable cover 17, which is received in a slot 19 in a side wall of the cable conduit 13. When the cover 17 is closed, the charging cable 20 is secured in the cable conduit 13 and protected against damage and dirt.

German patent application no. 10 2022 112278.6, filed May 17, 2022, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging station for an electric vehicle, the charging station comprising:
a horizontal boom with a charging cable conduit situated at a front side of the charging station at the base of the charging station, wherein the boom is connected by a swivel mechanism to the charging station and can swivel using the swivel mechanism horizontally to either side and be locked in a desired position.

2. The charging station according to claim 1, wherein the charging cable conduit runs along a longitudinal axis of the boom.

3. The charging station according to claim 1, wherein the boom has a movable cover, which is adapted to opening or closing the charging cable conduit.

4. The charging station according to claim 3, wherein the movable cover has a flap which can turn about a hinge running parallel to the charging cable conduit.

5. The charging station according to claim 3, wherein the movable cover has a slider which is received in a slot running in a side wall of the charging cable conduit.

6. The charging station according to claim 1, wherein the boom is provided with a warning marking.

7. The charging station according to claim 1, wherein the swivel mechanism is configured to be locked and unlocked by a foot switch.

8. The charging station according to claim 1, wherein the swivel mechanism is adapted to lift the boom up from the ground when the swivel mechanism is unlocked, and to lower the boom to the ground when the swivel mechanism is locked.

9. The charging station according to claim 1, having at least one charging receptacle on the front side of the charging station.

10. A method for operating a charging station having a horizontal boom with a charging cable conduit situated at a front side of the charging station at the base of the charging station, wherein the boom is connected by a swivel mechanism to the charging station and can swivel using the swivel mechanism horizontally to either side and be locked in a desired position, the method comprising:
swiveling the boom in a horizontal direction until it points in a direction of a charging socket of an electric vehicle being charged;
locking the boom in this position; and
introducing and securing a segment of a charging cable connecting the charging station and the electric vehicle into the charging cable conduit of the boom.
